(19) United States
(12) Patent Application Publication
(10) Pub. No.: US 2012/0253879 A1
(43) Pub. Date: Oct. 4, 2012

(54) Optimizing workforce capacity and capability

(76) Inventors: Cipriano A. Santos, Modesto, CA (US); Maria Teresa Gonzalez Diaz, Mountain View, CA (US); Xin Zhang, San Jose, CA (US); Shailendra K. Jain, Sunnyvale, CA (US); Andrei Alexandru Fuciec, Meyrin (CH); Haitao Li, San Louis, MO (US); Claudia Marquez-Nava, Toluca (MX); Christopher Mejia, Toluca (MX)

(21) Appl. No.: 13/077,932

(22) Filed: Mar. 31, 2011

(51) Int. Cl. G06Q 10/00

(52) U.S. Cl. 705/7.22; 705/7.11

(57) ABSTRACT

A workforce capacity and capability at an entity is optimized. Values for parameters related to the workforce capacity and capability at the entity are received. A workforce capacity and capability model is used to generate values for decision variables related to the workforce capacity and capability at the entity, based on the values for the parameters that have been received. The workforce capacity and capability model models uncertainty associated with a workforce. The values for the decision variables assist evaluation of workforce capacity and capability strategic decisions

### BACKGROUND

Entities like multinational corporations can employ tens if not hundreds of thousands of professionals worldwide, with more workers available to the entities on a contingent and contractual basis. This combined workforce of an entity is among the most valuable resources that the entity has at its disposal, particularly where the entity is concerned with providing services. Such entities align their workforce capacities having different skills, or capabilities, from various sources and geographical locations with their business goals and strategies to maximize revenue.

### BRIEF DESCRIPTION OF THE DRAWINGS

FIG. 1 is a flowchart of an example deterministic method for optimizing workforce capacity and capability at an entity.

FIG. 2 is a flowchart of an example non-deterministic method for optimizing workforce capacity and capability at an entity.

FIG. 3 is a diagram of an example system for optimizing workforce capacity and capability at an entity.

### DETAILED DESCRIPTION

As noted in the background, an entity aligns its workforce capacity and capability with its business goals and strategies to maximize revenue. Each fiscal year an entity may set target revenues for its different market offerings. Such target revenues often reflect the entity's strategic plan for the following fiscal year. The target revenues have to be allocated properly among various organizations of the entity. If the entity's regular fulltime workforce does not have sufficient capacity or capability to deliver the target revenues, gaps in terms of quantity and skill are identified. These gaps are then satisfied using alternative sources of labor, such as contingent workforce and third-party partners, as well as cross-training existing employees.

Disclosed herein are approaches to address the labor strategy optimization problem that determines both the level, or capacity, and the skill mix, or capability, of the workforce from different sources available to an entity to best support target revenues, so that entity-level gross margin is maximized. These approaches can provide an optimal labor strategy in the form of revenue allocation ratios. These ratios provide the entity with strategic planning decisions regarding how much of its service revenue can be delivered by its internal full-time employees, how many external full-time employees, such as contingent workforce and offshore workforce, should be used, and how much subcontracting to third-party partners and cross-training should be used.

One technique disclosed herein is a deterministic approach for optimizing workforce capacity and capability, using a deterministic workforce capacity and capability model. This deterministic problem can be formulated as a mixed integer linear programming (MILP) model to provide a cost-effective matching of workforce requirements with internal workforce, external workforce, and/or workforce that can be provided through cross-training. Sensitivity analysis can be performed so that the impact of various risks and uncertain factors on the optimal labor strategy and financial performance of the entity are understood.

Another technique disclosed herein is a non-deterministic approach for optimizing workforce capacity and capability, using a non-deterministic workforce capacity and capability model. This non-deterministic problem can be formulated as a stochastic optimization model via a two-stage stochastic program with simple resource. First-stage decision variables involve revenue allocation decisions that have to be made now. Second-stage decision variables involve decision that can then be made after various random parameters are realized. The stochastic model provides decision support under uncertainty, which avoids the need for and is generally more accurate than sensitivity analysis.

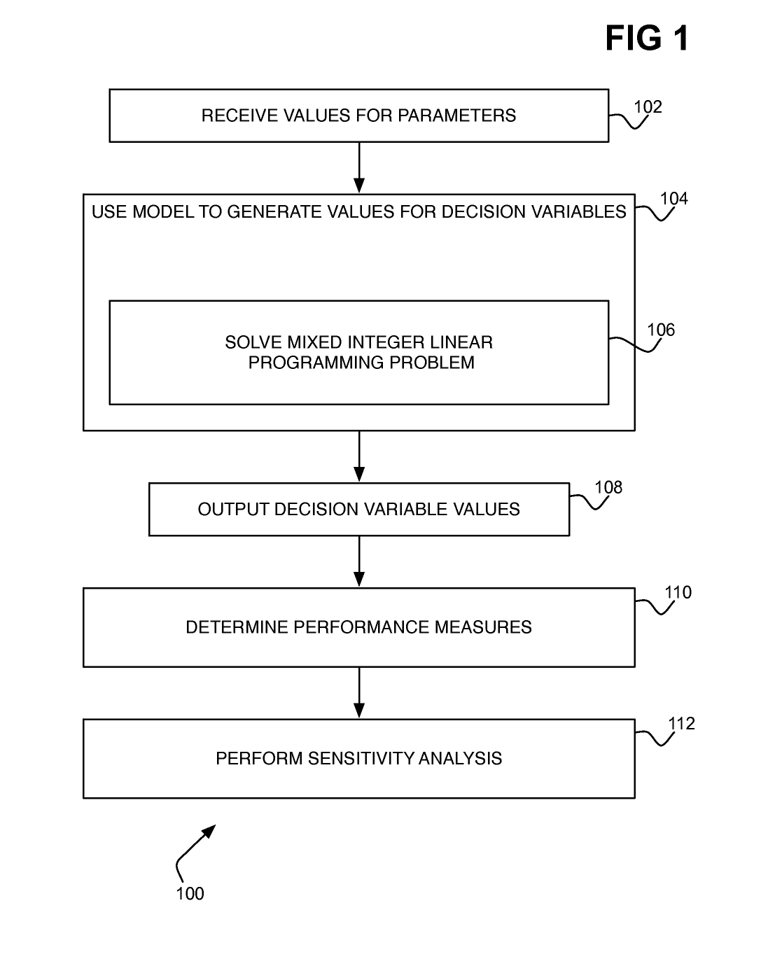

FIG. 1 shows an example deterministic method 100 for optimizing workforce capacity and capability at an entity. The entity can be a corporation, such as a multinational corporation, or another type of entity. The workforce capacity of the entity includes the entity's full-time employees, as well as other workforce at the entity's disposal. Such other workforce includes third-party partners and other contract-based workforce, as well as contingent workforce, and workforce available through cross-training existing employees. The capability of the entity includes the skill sets of the entity's full-time employees, as well as skill sets at the entity's disposal available from the other workforce that the entity can use.

The example method 100, as with other example methods disclosed herein, is performed by a processor, such as a processor of a computing device like a general-purpose computer. The method 100 may thus be implemented as a computer program that is stored on a non-transitory computer-readable data storage medium. Execution of the computer program by a processor therefore results in performance of the method 100.

The example method 100 receives values for parameters related to the workforce capacity and capability at the entity (102). The parameter values may be received from a user, via a graphical user interface, or in another manner. The parameters for which values are received by the method 100 can be expressed in terms of a number of sets and indices, as follows.

A set M specifies a set of market offerings by the entity. The market offerings by the entity are the collection of services that the entity offers to clients and customers, in relation to which the entity wishes to optimize its workforce capacity and capability. There is an index m∈M that specifies an index of the market offerings.

At the beginning of a fiscal cycle, the entity may specify forecasted revenue Yₘ for each market offering, based on confirmed and anticipated orders, and target market share levels. The labor strategy optimization problem is thus to determine a feasible revenue allocation plan for various workforce sources to maximize total gross margin. A solution to the problem provides also recommendations about employees that can be cross-trained to increase regular workforce (i.e., employed by the entity itself) utilization.

A set L specifies a set of workforce sources available to the entity. The workforce sources can differ geographically and also in the nature of the revenue that these sources are able to generate. For instance, some workforce sources that generate revenue are owned by the entity itself, whereas other workforce sources do not generate revenue that is owned by the entity. The set of entity-owned workforce sources is specified by L^{E}, and is a subset of L. That is, L^{E}⊂L. Furthermore, there is an index l∈L that specifies an index of the workforce sources.

A bill-of-labor translates, or decomposes, service demand into a hierarchical structure of labor. The entity's bill-of-labor may have a three-level structure. At the first level, the forecasted revenue can be allocated into revenues assigned to different workforce sources. The entity may specify a lower bound ratio θₘ^{l} for this allocation. That is, at least θₘ^{l} of the forecasted or target revenue Yₘ of marketing offering m is allocated to source l∈L .

At the second level, the entity-owned revenue can be converted to the number of fulltime employees (FTE), which is further divided into revenues to be generated by different types of FTE. A set F specifies a set of FTE types at the entity, where each FTE type is able to perform a different type of workforce role. An index f∈F is an index of the FTE types. Furthermore, F⊃{reg,ctw}, where reg represents regular FTEs at the entity and ctw represents contingent FTEs at the entity.

At the third level, FTE can be decomposed into a set R that specifies a set of workforce roles, or skills. An index r∈R is an index of the workforce roles. The quantity of regular FTE in role r∈R of marketing offering m from an entity-owned source l∈L^{E} cannot exceed an available workforce inventory lₘᵣ^{l}.

As noted above, cross-training can occur so that an FTE that performs one workforce role can be trained to perform a different workforce rule. As such, there is a set T⊂(M×R)×(M×R). This nomenclature specifies a set of valid cross-trainings from one pair of a market offering and a role to another pair of a market offering and a role.

In light of the above sets and indices, the parameters for which values are received in part 102 of the example method 100 can include the following. A parameter Yₘ, as noted above, specifies the target revenue by the entity for marking offering m. A parameter ρₘ^{l} specifies a cost ratio of revenue generated by a non-entity-owned source

$$I ∈ \frac{L}{{L}^{E}}$$

to the target revenue in market offering m. A parameter cₘₗ^{f} specifies cost per FTE of type f per day in marketing offering m from source l. A parameter η specifies a number of working days over a planning horizon for which the workforce capacity and capability of the entity is to be optimized.

Another parameter μₘᵣ^{lm′r′} specifies a percentage of utilization that is lost due to lead time spent to cross-train an FTE from source l in role r of market offering m to role r′ of market offering m′. Cross-training may be possible according to entity-specific rules. It is noted that cross-training within the same market offering is typically more flexible than cross-training across market offerings. However, more generally, the entity itself can dictate which cross-training, if any, is possible. A further parameter θₘ^{l} specifies a lower bound on a percentage of revenue in market offering m allocated to source l. A parameter τₘ^{l} specifies an average discounted external rate of an FTE.

Another parameter λₘ^{l} specifies a risk factor for an FTE in marketing offering m from source l. This risk factor thus captures the percentage of time that is not billable to clients or customers due to learning or other potential disruptions of projections. Furthermore, a parameter uₘₗ^{f} specifies a percentage of time of an FTE of type f in market offering m from source l that generates revenue. This is a commitment rate, because a regular or a contingent workforce (CTW) FTE may not be 100% committed to a given projected. It is noted that 1−u in this respect represents the percentage of time that does not generate revenue, such as bidding and pre-sale activities. Both the risk factor λ and the commitment rate u may be uncertain.

Another parameter τₘᵣ^{l} specifies a percentage of FTE of role r in market offering m from source l. A parameter lₘᵣ^{l} specifies an available inventory of FTE of role r in market offering m from source l, as noted above. Another parameter is a large positive number M, such as greater than a threshold, and which is used to control the amount of cross-training that is desired, where the larger the value of the parameter, the less cross-training that is recommended by the example method 100. A final parameter αₘₗᵣ specifies a cost of the idled regular FTE of role r in market offering m from source l.

Once the values for the parameters have been received in part 102, the example method 100 uses a deterministic workforce capacity and capability model to generate values for decision variables related to the workforce capacity and capability at the entity, based on these parameter values (104). The decision variables can thus be used by the entity to plan its workforce capacity and capability. The decision variable values represent a solution to the labor strategy optimization problem.

A decision variable xₘ^{l} specifies revenue allocated to source l in market offering m. A decision variable yₘ^{l} specifies FTE for market offering m from source l. A decision variable yₘₗ^{f} specifies FTE of type f for market offering m from source l, and a decision variable zₘₗᵣ^{f} specifies FTE in role r of type f for market offering m from source l.

A decision variable Xₘᵣ^{lm′r′} specifies regular FTE from source l in role r of market offering m trained to role r′ of market offering m′. Another decision variable Eₘₗᵣ specifies idled regular FTE of role r in market offering m from source l. A decision variable δ_{E}_{ₘₗᵣ}:=1 specifies whether the idled regular FTE of role r in market offering m from source l can be positive. Similarly, a decision variable

$${δ}_{{x}_{mr}^{{lm}^{′} {r}^{′}}} := 1$$

specifies whether cross-training from source l in role r of market offering m to role r′ of market offering m′ can be positive.

The deterministic workforce capacity and capability model can be expressed as a MILP problem that is solved to maximize an expression specified by the deterministic model, given constraints specified by this model (106). The MILP problem can be solved using existing mathematical tools. One example of such a mathematical tool is the Gurobi™ Optimizer software package, available from Gurobi Optimization, of Houston, Tex.

The objective function can be generally expressed as A−B−C−D−E. In this expression, A specifies total revenue allocated, B specifies a cost of service delivery from non-entity-owned sources, and C specifies a total entity-owned workforce cost. Furthermore, D specifies a total cross-training cost, and E specifies a penalty of idled regular workforce.

The constraints can generally include the following. A first constraint is to ensure that total revenue allocated to workforce sources equals a forecasted revenue target in each of a plurality of market offerings. A second constraint is to impose a lower bound on the total revenue as allocated to the workforce sources, which can be relaxed if the entity does not have a lower bound to allocate its target revenue to different sources. A third constraint is to convert revenues in currency amounts into a number of FTEs needed while considering one or more risk factors. A fourth constraint is to enforce a sum of different types of FTE equals a total number of the FTEs needed. A fifth constraint specifies FTEs needed per FTE role.

A sixth constraint specifies a composition of FTE in terms of FTE roles, which can be relaxed if the entity has flexibility in the workforce's composition of roles. A seventh constraint is to balance an initial inventory, a reduced regular FTE used for cross-training, an increased regular FTE trained from other roles, and an idled regular FTE. An eighth constraint is to ensure that FTEs used for cross-training cannot exceed an available inventory. A ninth constraint is to ensure that cross-trained FTEs cannot exceed a final regular FTE number, where as a tenth constraint to forbid cross-training where impermissible. One or more eleventh constraints are to prevent cross-training idled regular FTEs. A twelfth constraint is to define decision variable domains.

More specifically, the objective function that is maximized to solve the MILP problem can be expressed as ΣₘΣₗxₘ^{l}−ΣₘΣ_{l∈L/L}Eρₘ^{l}xₘ^{l}−ηΣₘΣ_{l∈L}EΣ_{f}cₘₗ^{f}−ηΣₘΣ_{l∈L}EΣᵣcₘₗ^{reg}μₘᵣ^{lm′r′}Xₘᵣ^{lm′r′}−ηΣₘΣ_{l∈L}EΣᵣαₘₗᵣEₘₗᵣ. The twelve constraints noted above can be more specifically expressed as follows. The first constraint is expressed as Σₗxₘ^{l}=Yₘ,∀m∈M. The second constraint is expressed as xₘ^{l}≧θₘ^{l}Yₘ,∀m∈M,l∈L. The third constraint is expressed as τₘ^{l}η[Σ_{f}uₘₗ^{f}yₘₗ^{f}−λₘ^{l}yₘ^{l}]=xₘ^{l},∀m∈M,l∈L^{E}. The fourth constraint is expressed as Σ_{f}yₘₗ^{f}=yₘ^{l},∀m∈M,l∈L^{E}. The fifth constraint is expressed as Σᵣzₘₗᵣ^{f}=yₘₗ^{f},∀m∈M,l∈L^{E},f∈F. The sixth constraint is expressed as Σ_{f}zₘₗᵣ^{f}=πₘᵣ^{l}yₘ^{l},∀m∈M,l∈L^{E},r∈R.

The seventh constraint is expressed as zₘₗᵣ^{reg}=lₘᵣ^{l}−Σ_{m′}Σ_{r′}Xₘᵣ^{lm′r′}+Σ_{m′}Σ_{r′}(1−μ_{m′r′}^{lmr})X_{m′r′}^{lmr}−Eₘₗᵣ, ∀m∈M,l∈L^{E},r∈R. The eighth constraint is expressed as Σ_{m′}Σ_{r′}Xₘᵣ^{lm′r′}≦lₘᵣ^{l},∀m∈M,l∈L_{E},r∈R. The ninth constraint is expressed as Σ_{m′}Σ_{r′}(1−μ_{m′r′}^{lmr})X_{m′r′}^{lmr}≦zₘₗᵣ^{reg},∀m∈M,l∈L^{E},r∈R. The tenth constraint is expressed as Xₘᵣ^{lm′r′}=0,∀(mr,m′r′)∉T,l∈L^{E}. The eleventh constraints are expressed as Mgδ_{E}_{ₘₗᵣ}>Eₘₗᵣ,∀,∀m∈M,l∈L^{E},r∈R;

$$Mg {δ}_{{X}_{mr}^{{lm}^{′} {r}^{′}}} \geq {X}_{mr}^{{lm}^{′} {r}^{′}} , ∀ ( mr , {m}^{′} {r}^{′} ) ∈ T , I ∈ {L}^{E} ;$$

$${δ}_{{E}_{mlr} +} {δ}_{{x}_{mr}^{{lm}^{′} {r}^{′}}} \leq 1 , ∀ ( mr , {m}^{′} {r}^{′} ) ∈ T , I ∈ {L}^{E} ;$$

$$and , \\ {δ}_{{E}_{mlr}} , {{δ}_{X}}_{mr}^{{lm}^{′} {r}^{′}} ∈ \{ 0 , 1 \} .$$

The twelfth constraint is expressed as xₘ^{l},yₘ^{l},yₘₗ^{f},zₘₗᵣ^{f},Xₘᵣ^{lm′r′}≧0.

Solving the MILP problem to maximize the expression noted above, given the constraints noted above, provides values for the decision variables that have been described. As such, the decision variable values can be output by the example method 100 (108), so that a user is able to employ these values in optimizing the workforce capacity and capability at the entity. Such output can include displaying the values on a graphical-user interface provided on a display device, as well as outputting the values on a printed medium, and storing the values on a non-transitory computer-readable data storage medium for later analysis.

The example method 100 can further determine performance measures from the decision variable values to assist the entity in evaluating its labor strategy (112). For the first level of the bill-of-labor, the percentage of target revenue allocated to each workforce source may be determined. The percentage of revenue in market offering m allocated to source l, for instance, is

$$\frac{{x}_{m}^{l}}{{\sum }_{l} {x}_{m}^{l}} , ∀ m ∈ M , I ∈ L .$$

This performance measure captures the entity's strategic staffing plan in each market offering. That is, this measure captures how much revenue in a particular market offering m will be delivered by internal FTE, as well as by CTW, and by third-party partners.

At the second level of the bill-of-labor, the percentage of services delivered by different entity-owned workforce f can be determined as

$$\frac{{τ}_{m}^{l} η ( {u}_{ml}^{f} - {λ}_{m}^{l} ) {y}_{ml}^{f}}{{x}_{m}^{l}} , ∀ m ∈ M , I ∈ L , f ∈ F .$$

This performance measure provides information about the optimal composition of the entity-owned FTE. For instance, the entity-owned FTE composition may be compared using this performance measure to external CTW FTE.

The labor productivity measuring the efficiency of service delivery can be determined as

$$\frac{{\sum }_{m} {x}_{m}^{l}}{D 1 + D 2 + D 3 + D 4} , ∀ I ∈ L ,$$

where D1=Σ_{l∈L/L}Eρₘ^{l}xₘ^{l}, D2=ηΣₘΣ_{l∈L}EΣ_{f}cₘₗ^{f}yₘₗ^{f}, D3=ηΣₘΣ_{l∈L}EΣᵣcₘₗ^{reg}μₘᵣ^{lm′r′}, and D4=ηΣₘΣ_{l∈L}EΣᵣαₘₗᵣEₘₗᵣ. In this performance measure, the numerator is the total revenue to be generated by the workforce at location (i.e., source) l for the market offerings. The denominator includes four cost components D1,D2,D3, and D4. The cost component D1 is the cost of non-entity-owned service, and the cost component D2 is the cost of entity-owned service. The cost component D3 is the cost of cross-training, and the cost component D4 is the penalty cost of idled regular workforce.

The overall utilization of the regular workforce from source l is another performance measure. This performance measure can be determined as the ratio between utilized workforce capacity and available inventory. More specifically, this measure is

$$1 - \frac{{\sum }_{m} {\sum }_{r} {E}_{mlr}}{{\sum }_{m} {\sum }_{r} {I}_{mr}^{l}} , ∀ I ∈ I ,$$

Because the workforce capacity and capability model of the example method 100 is a deterministic model, the decision variable values are generated using the model based on specified values for the parameters that have been received. However, a complete set of the parameters may not all be known, and therefore have to be estimated. Depending on these estimates, the resulting values for the decision variables may vary immensely. To determine the impact of such parameter estimation, then, sensitivity analysis can be performed on the parameters to determine the effects of parameter change on the values for the decision variables (112).

More specifically, if a particular parameter has to be estimated, different values for the parameter may be input into the deterministic workforce capability and capability model, to assess how much different decision variables change in value in accordance with changes in the values for the parameter in question. As such, the sensitivity of each decision variable to a parameter can be determined. Knowing this sensitivity can assist the entity in determining how accurate the decision variable values are, in light of uncertainty in one or more of the parameters. For example, sensitivity analysis may show that if a particular parameter varies by X1 percent from its estimated value, then a given decision variable may correspondingly vary by X2 percent from its determined value.

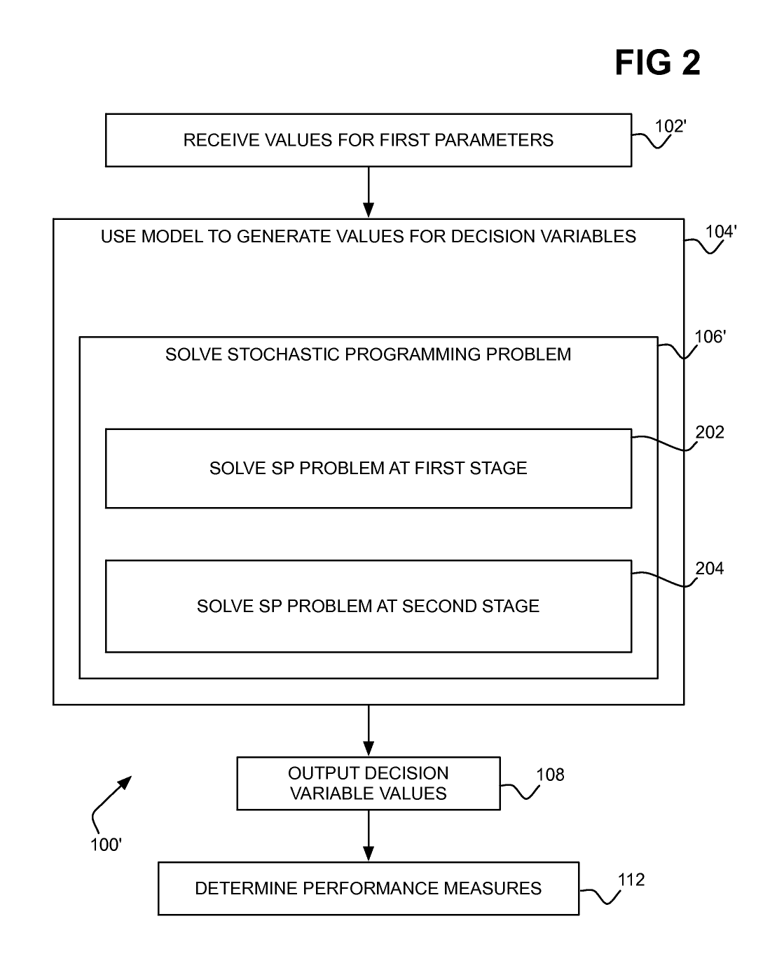

However, another approach to overcoming this uncertainty is to employ a non-deterministic model in lieu of a deterministic model. FIG. 2 shows an example non-deterministic method 100′ for optimizing workforce capacity and capability at an entity. Primed reference numbers in FIG. 2 correspond to their non-primed counterparts in FIG. 1, but vary to some extent insofar as the method 100′ is non-deterministic whereas the method 100 is deterministic.

Whereas the example deterministic method 100 employs point estimates of parameters that are effectively random, such as commitment rate u and risk factor λ, the example non-deterministic method 100 more accurately treats them as random parameters. The example method 100′ receives values for first parameters related to the workforce capacity and capability at the entity (102′). The first parameters are non-random parameters, which the entity can provide with a relatively high degree of certainty. These first parameters can be the same as the parameters that the example deterministic method 100 receives in part 102, except that the commitment rate u and risk factor A are not part of the first parameters for which values are received in part 102′, because these parameters are treated as random parameters.

Therefore, in addition to the first parameters for which values are received in part 102′, the example method 100′ considers at least two second parameters that are random. One random parameter is θₘₗ^{f}^{ₒ}, which specifies a commitment rate of type f FTE in market offering m from source l. Another random parameter is λₘ^{ot}^{ₒ}, which specifies a risk factor of an FTE in market offering m from source l. Because the method 100′ is non-deterministic, estimated values for these random parameters do not have to be received in part 102′, whereas in the deterministic method 100, estimated values for their non-random counterparts u and λ do have to be received.

Once the values for the first parameters have been received in part 102′, the example method 100′ uses a non-deterministic workforce capacity and capability model to generate values for decision variables related to the workforce capacity and capability at the entity, based on these first non-random parameter values, as well as based on the second random parameters (104′). As in the method 100, the decision variables in the method 100′ can thus be used by the entity to plan its workforce capacity and capability. The decision variable values represent a solution to the labor strategy optimization problem.

The decision variables can include first-stage decision variables and second-stage decision variables. The first-stage decision variables include allocation of target revenues into different workforce sources that corresponds to a first-level decomposition of the labor strategy optimization problem. Such decision can be made immediately so that budget policies can be determined for each market offering and workforce source for the entity to start or continue operation. For instance, revenue allocated to offshore workforce needs should be known immediately for coordinating such operations. Revenue allocation to third-party partners likewise can be specified immediately, for negotiations to proceed with these partners.

However, due to the uncertain nature of various risks, such as the commitment rate u and the risk factor λ involved in a second-level decomposition, the number of FTEs to support the allocated revenue is uncertain. As such, the second-stage decision variables specify these and other values that cannot be, and do not have to be, determined right away. Rather, such second-stage decision-variables do not have to be determined until the random parameters have been realized.

The decision variables in the example method 100′ can be expressed in terms of a number of sets and indices, in addition to the sets and indices specified above in relation to the example method 100, as follows. A set Ω specifies a set of scenarios. An index ω∈Ω specifies a scenario representing a realization of the second parameters. A probability p^{ω} specifying a probability that scenario ω occurs, A scenario is one instantiation realizable by the random parameters. That is, when the random parameters take on a particular value, such a unique tuple or pair of values is considered a scenario.

The first-stage decision variables thus include a first-stage decision variable xₘ^{l}, which specifies revenue allocated to source l in market offering m, as noted above. The second-stage decision variables include a second-stage decision variable yₘ^{lω} specifying FTE for market offering m from source l in scenario ω. Another second-stage decision variable is yₘₗ^{fω}, which FTE of type f for market offering m from source l in scenario ω. The second-stage decision variables include zₘₗᵣ^{fω} specifying FTE in role r of type f for market offering m from source l in scenario ω. A further second-stage decision variable X_{mrω}^{lm′r′} specifies regular FTE from source l in role r of market offering m trained to role r′ of market offering m′ in scenario ω.

A second-stage decision variable Eₘₗᵣ^{ω} specifies idled regular FTE of role r in market offering m from source l in scenario ω. A second-stage decision variable δ_{E}_{ₘₗᵣ}^{ω}:=1 specifies whether the idled regular FTE of role r in market offering m from source l can be positive in scenario ω. Similarly, a second-stage decision variable

$${δ}_{{X}_{mr}^{{lm}^{′} {r}^{′}}}^{ω} := 1$$

specifies whether cross-training from source l in role r of market offering m to role r′ of market offering m′ can be positive in scenario ω. Finally, a second-stage decision variable αₘₗᵣ^{ω} specifies a cost of the idled regular FTE of role r in market offering m from source l in scenario ω.

The non-deterministic workforce capacity and capability problem can be modeled as a two-stage stochastic program (SP) with simple recourse. The deterministic equivalent formulation of the SP model can be specified (106′), and can be solved using existing mathematical tools, such as the Gurobi Optimization software package noted above.

The objective function can be generally expressed as A−B−C−D−E. In this expression, A specifies total revenue allocated, B specifies a cost of service delivery from non-entity-owned sources, and C specifies a total entity-owned workforce cost weighted over a plurality of probabilistic scenarios. Furthermore, D specifies a total cross-training cost weighted over the probabilistic scenarios, and E specifies a penalty of idled regular workforce weighted over the probabilistic scenarios.

The constraints can generally include the following. A first constraint is to ensure that total revenue allocated to workforce sources equals a forecasted revenue target in each of a plurality of market offerings. A second constraint is to impose a lower bound on the total revenue as allocated to the workforce sources. A third constraint is to convert revenues in currency amounts into a number of FTEs needed while considering one or more risk factors, and as associated with a particular probabilistic scenario. A fourth constraint is to enforce a sum of different types of FTE equals a total number of the FTEs needed, as associated with the particular probabilistic scenario. A fifth constraint is to specify FTEs needed per FTE role, as associated with the particular probabilistic scenario. A sixth constraint specifies a composition of FTE in terms of FTE roles, as associated with the particular probabilistic scenario.

A seventh constraint is to balance an initial inventory, a reduced regular FTE used for cross-training, an increased regular FTE trained from other roles, and an idled regular FTE, as associated with the particular probabilistic scenario. An eighth constraint is to ensure that FTEs used for cross-training cannot exceed an available inventory, as associated with the particular probabilistic scenario. A ninth constraint is to ensure that that cross-trained FTEs cannot exceed a final regular FTE number, as associated with the particular probabilistic scenario. A tenth constraint is to forbid cross-training where impermissible, as associated with the particular probabilistic scenario. One or more eleventh constraints are to prevent cross-training idled regular FTEs, as associated with the particular probabilistic scenario. A twelfth constraint is to define decision variable domains, as associated with the particular probabilistic scenario.

More specifically, the expression that is maximized to solve the SP problem can be expressed as

$${\sum }_{m} {\sum }_{l} {x}_{m}^{l} - {\sum }_{m} {\sum }_{I ∈ L / L} E {ρ}_{m}^{l} {x}_{m}^{l} - {\sum }_{ω} {p}^{ω} ( η {\sum }_{m} {\sum }_{I ∈ L} E {\sum }_{f} {c}_{ml}^{f ω} + η {\sum }_{m} {\sum }_{I ∈ L} E {\sum }_{r} {c}_{ml}^{reg} {μ}_{mr}^{{lm}^{′} {r}^{′}} {X}_{mr ω}^{{lm}^{′} r} + η {\sum }_{m} {\sum }_{I ∈ L} E {\sum }_{r} {α}_{mlr} {E}_{mlr}^{ω} ) .$$

The twelve constraints noted above can be more specifically expressed as follows. The first constraint is expressed as Σₗxₘ^{l}=Yₘ,∀m∈M. The second constraint is expressed as xₘ^{l}≧θₘ^{l}Yₘ,∀m∈M,l∈L. The third constraint is expressed as τₘ^{l}η[Σ_{f}uₘₗ^{fω}yₘₗ^{fω}−λₘ^{lω}yₘ^{lω}]=xₘ^{l},∀m∈M,l∈L^{E},ω∈Ω. The fourth constraint is expressed as Σ_{f}yₘₗ^{fω}=yₘ^{lω},∀m∈M,l∈L^{E},ω∈Ω. The fifth constraint is expressed as Σᵣzₘₗᵣ^{fω}=yₘₗ^{fω},∀m∈M,l∈L^{E},f∈F,ω∈Ω. The sixth constraint is expressed as Σ_{f}zₘₗᵣ^{fω}=πₘᵣ^{l}yₘ^{lω},∀m∈M,l∈L^{E},r∈R,ω∈Ω.

The seventh constraint is expressed as zₘₗᵣ^{reg,ω}=lₘᵣ^{l}−Σ_{m′}Σ_{r′}X_{mrω}^{lm′r′}+Σ_{m′}Σ_{r′}(1−μ_{m′r′}^{lmr})X_{m′r′ω}^{lmr}−Eₘₗᵣ^{ω}, ∀m∈M,l∈L^{E},r∈R,ω∈Ω. The eighth constraint is expressed as Σ_{m′}Σ_{r′}X_{mrω}^{lm′r′}≦lₘᵣ^{l},∀m∈M,l∈L^{E},r∈R,ω∈Ω. The ninth constraint is expressed as Σ_{m′}Σ_{r′}(1−μ_{m′r′}^{lmr})X_{m′r′ω}^{lmr}≦zₘₗᵣ^{reg,ω},∀m∈M,l∈L^{E},r∈R,ω∈Ω. The tenth constraint is expressed as X_{mrω}^{lm′r′}=0,∀(mr,m′r′)∉T,l∈L^{E},ω∈Ω. The eleventh constraints are expressed as

$$Mg {δ}_{{E}_{mlr}}^{ω} > {E}_{mlr} , ∀ , ∀ m ∈ M , I ∈ {L}^{E} , r ∈ R , ω ∈ Ω ;$$

$$Mg {δ}_{{X}_{mr}^{{lm}^{′} {r}^{′}}}^{ω} \geq {X}_{mr ω}^{{lm}^{′} {r}^{′}} , ∀ ( mr , {m}^{′} {r}^{′} ) ∈ T , I ∈ {L}^{E} , ω ∈ Ω ;$$

$${δ}_{{E}_{{ω}_{mlr}}} + {δ}_{{X}_{mr}^{{lm}^{′} {r}^{′}}}^{ω} \leq 1 , ∀ ( mr , {m}^{′} {r}^{′} ) ∈ T , I ∈ {L}^{E} , ω ∈ Ω ;$$

$$and , \\ {δ}_{{E}_{mlr}}^{ω} , {δ}_{{E}_{mlr}}^{ω} , {δ}_{{X}_{mr}^{{lm}^{′} {r}^{′}}}^{ω} ∈ \{ 0 , 1 \} , ω ∈ Ω .$$

The twelfth constraint is expressed as xₘ^{l},yₘ^{lω},yₘₗ^{fω},zₘₗᵣ^{fω},X_{mrω}^{lm′r′}≧0.

The SP problem can be solved in two different stages. At a first stage, the example method 100′ solves the SP problem to generate values for the first-stage decision variables to provide an estimated solution to the SP problem (202). The first stage can be performed immediately—i.e., “right now”—because the first stage does not involve random parameters. By comparison, the method 100′ solves the SP problem in the second stage (204), by realizing the random parameters for a particular scenario. That is, the second stage is associated with particular scenarios of realization of the random parameters. The second-stage decision variable may thus be referred to as recourse variables. The first-stage decision variables can correspond to first-level budget allocation decisions that are to be made among different market offerings and locations. Based on a realized scenario of commitment rate and risk factor, for instance, second-stage, or recourse, decision variables are then solved for, and which correspond to lower-level staffing decisions regarding FTE, cross-training, and so on.

Solving the SP problem at either stage to maximize the expression noted above, given the constraints noted above, provides values for the corresponding stage of decision variables that have been described. As such, the decision variable values in question can be output by the example method 100′ (108), in the same manner as described above in relation to the example method 100. The method 100′ can further determine performance measures from the decision variable values to assist the entity in evaluating its labor strategy (112), also in the same manner as described above in relation to the method 100.

Because the workforce capacity and capability model of the example method 100′ is a non-deterministic model, the decision variable values are generated using the model based on random parameters that assume probabilistic distributions. Sensitivity analysis does not have to be performed in the non-deterministic method 100′ as it is in the deterministic method 100. This is because solving the SP problem itself provides for decision support under uncertain conditions.

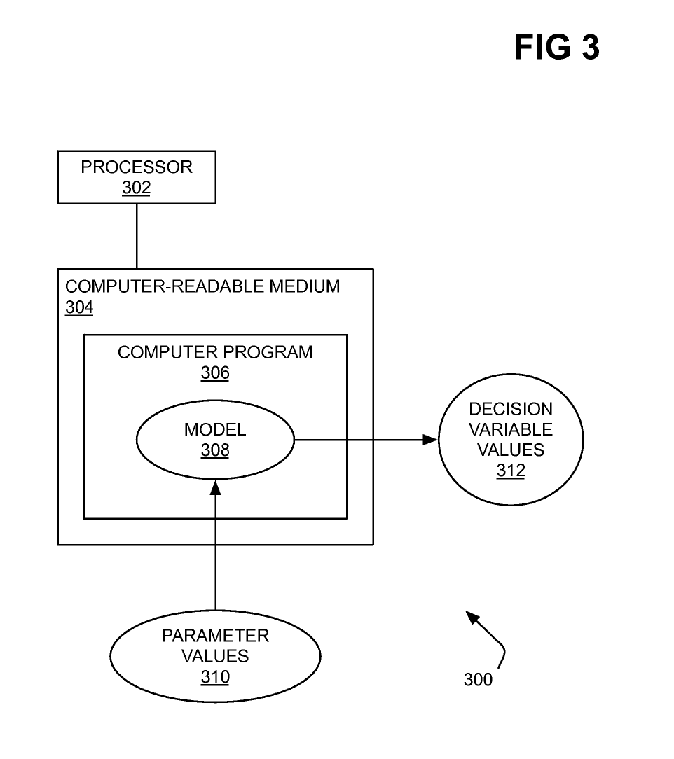

FIG. 3 shows an example system 300. The system 300 can be implemented over one or more computing devices, such as general-purpose computers. The system 300 includes at least a processor 302 and a non-transitory computer-readable data storage medium 304. The computer-readable medium 304 stores a computer program 306. Execution of the computer program 306 by the processor 302 causes the deterministic method 100 or the non-deterministic method 100′ to be performed.

As such, the computer program 306 implements or otherwise uses a workforce capacity and capability model 308, such as a deterministic model or a non-deterministic model. Parameter values 310 are input into the model 308, and the computer program uses the model 308 to generate decision variable values 312. The parameter values 310 can be those input in part 102 of the deterministic method 100, or those input in part 102′ of the non-deterministic method 100. Likewise, the decision variable values 312 may be the decision variable values output in part 108 of the deterministic method 100, or the first-stage and/or second-stage decision variable values output in part 108 of the non-deterministic method 100′.

1. A method for optimizing a workforce capacity and capability at an entity, comprising:
receiving values for a plurality of parameters related to the workforce capacity and capability at the entity, by a processor; and,
using a workforce capacity and capability model, by the processor, to generate values for a plurality of decision variables related to the workforce capacity and capability at the entity, based on the values for the parameters that have been received, wherein
the workforce capacity and capability model models uncertainty associated with a workforce,
the values for the decision variables assist evaluation of workforce capacity and capability strategic decisions, and
the workforce capacity and capability model maximizes an expression A−B−C−D−E, where A specifies total revenue allocated, B specifies a cost of service delivery from non-entity-owned sources, C specifies a total entity-owned workforce cost, D specifies a total cross-training cost, and E specifies a penalty of idled regular workforce.

2. The method of claim 1, further comprising determining one or more performance measures, by the processor, from the values for the decision variables generated using the workforce capacity and capability model.

3. The method of claim 1, wherein the workforce capacity and capability model is a deterministic model.

4. The method of claim 3, wherein using the workforce capacity and capability model comprises solving a mixed integer linear programming (MILP) problem to maximize the expression, given a plurality of constraints specified by the workforce capacity and capability model.

5. The method of claim 3, further comprising performing sensitivity analysis, by the processor, on the parameters to determine effects of uncertainty in the parameters on the values for the decision variables generated using the workforce capacity and capability model,
wherein the value for each of one or more of the parameters is a priori unknown and therefore estimated.

6. (canceled)

7. The method of claim 4, wherein the constraints comprise:
a first constraint to ensure that a total revenue allocated to workforce sources equals a forecasted revenue target in each of a plurality of market offerings;
a second constraint to impose a lower bound on the total revenue as allocated to the workforce sources;
a third constraint to convert revenues in currency amounts into a number of full-time employees (FTEs) needed while considering one or more risk factors;
a fourth constraint to enforce a sum of different types of FTE equals a total number of the FTEs needed;
a fifth constraint to specify FTEs needed per FTE role;
a sixth constraint to specify a composition of FTE in terms of FTE roles;
a seventh constraint to balance an initial inventory, a reduced regular FTE used for cross-training, an increased regular FTE trained from other roles, and an idled regular FTE;
an eighth constraint to ensure that FTEs used for cross-training cannot exceed an available inventory;
a ninth constraint to ensure that that cross-trained FTEs cannot exceed a final regular FTE number;
a tenth constraint to forbid cross-training where impermissible;
one or more eleventh constraints to prevent cross-training idled regular FTEs; and,
a twelfth constraint to define decision variable domains.

8. The method of claim 4, wherein M specifies a set of market offerings by the entity, L specifies a set of workforce sources available to the entity, R specifies a set of workforce roles, F specifies a set of full-time employee (FTE) types at the entity, m∈M specifies an index of the market offerings, l∈L specifies an index of the workforce sources, r∈R specifies an index of the workforce roles, f∈F specifies an index of the FTE types, F⊃{reg, ctw} such that reg represents regular FTEs at the entity and ctw represents contingent FTEs at the entity, and T⊂(M×R)×(M×R) specifies a set of valid cross-trainings from one pair of a market offering and a role to another pair of a market offering and a role,
wherein the parameters comprise: Yₘ specifying target revenue by the entity for marking offering m; ρₘ^{l} specifying a cost ratio of revenue generated by a non-entity-owned source
$$I ∈ \frac{L}{{L}^{E}}$$
to the target revenue in market offering m; cₘₗ^{f} specifying cost per FTE of type f per day in marketing offering m from source l; η specifying a number of working days over a planning horizon; μₘᵣ^{lm′r′} specifying a percentage of utilization that is lost due to lead time spent to cross-train an FTE from source l in role r of market offering m to role r′ of market offering m′; θₘ^{l} specifying a lower bound on a percentage of revenue in market offering m allocated to source l; Σₘ^{l} specifying an average discounted external rate of an FTE; uₘₗ^{f} specifying a percentage of time of an FTE of type f in market offering m from source l that generates revenue; λₘ^{l} specifying a risk factor for an FTE in marketing offering m from source l; πₘᵣ^{l} specifying a percentage of FTE of role r in market offering m from source l; lₘᵣ^{l} specifying an available inventory of FTE of role r in market offering m from source l; a large positive number M, such as greater than a threshold; and, αₘₗᵣ specifying a cost of the idled regular FTE of role r in market offering m from source l,
and wherein the decision variable comprise: xₘ^{l} specifying revenue allocated to source l in market offering m; yₘ^{l} specifying FTE for market offering m from source l; yₘₗ^{f} specifying FTE of type f for market offering m from source l; zₘₗᵣ^{f} specifying FTE in role r of type f for market offering m from source l; Xₘᵣ^{lm′r′} specifying regular FTE from source l in role r of market offering m trained to role r′ of market offering m′; Eₘₗᵣ specifying idled regular FTE of role r in market offering m from source l; and, δ_{E}_{ₘₗᵣ}:=1 specifying whether the idled regular FTE of role r in market offering m from source l can be positive;
$${δ}_{{X}_{mr}^{{lm}^{′} {r}^{′}}} := 1$$
specifying whether cross-training from source l in role r of market offering m to role r′ of market offering m′ can be positive.

9. The method of claim 8, wherein the expression is ΣₘΣₗxₘ^{l}−ΣₘΣ_{l∈L/L}Eρₘ^{l}xₘ^{l}−ηΣₘΣ_{l∈L}EΣ_{f}cₘₗ^{f}−ηΣₘΣ_{l∈L}EΣᵣcₘₗ^{reg}μₘᵣ^{lm′r′}Xₘᵣ^{lm′r′}−ηΣₘΣ_{l∈L}EΣᵣαₘₗᵣEₘₗᵣ,
and wherein the constraints comprise: Σₗxₘ^{l}=Yₘ,∀m∈M; xₘ^{l}≧θₘ^{l}Yₘ,∀m∈M,l∈L; τₘ^{l}η[Σ_{f}uₘₗ^{f}yₘₗ^{f}−λₘ^{l}yₘ^{l}]=xₘ^{l},∀m∈M,l∈L^{E}; Σ_{f}yₘₗ^{f}=yₘ^{l},∀m∈M,l∈L^{E}; Σᵣzₘₗᵣ^{f}=yₘₗ^{f},∀m∈M,l∈L^{E},f∈F; Σ_{f}zₘₗᵣ^{f}=πₘᵣ^{l}yₘ^{l},∀m∈M,l∈L^{E},r∈R; zₘₗᵣ^{reg}=lₘᵣ^{l}−Σ_{m′}Σ_{r′}Xₘᵣ^{lm′r′}+Σ_{m′}Σ_{r′}(1−μ_{m′r′}^{lmr})X_{m′r′}^{lmr}−Eₘₗᵣ, ∀m∈M,l∈L^{E},r∈R; Σ_{m′}Σ_{r′}Xₘᵣ^{lm′r′}≦lₘᵣ^{l},∀m∈M,l∈L^{E},r∈R; Σ_{m′}Σ_{r′}(1−μ_{m′r′}^{lmr})X_{m′r′}^{lmr}≦zₘₗᵣ^{reg},∀m∈M,l∈L^{E},r∈R; Xₘᵣ^{lm′r′}=0,∀(mr,m′r′)∉T,l∈L^{E}; M□δ_{E}_{ₘₗᵣ}>Eₘₗᵣ,∀,∀m∈M,l∈L^{E},r∈R;
$$M {•δ}_{{X}_{mr}^{{lm}^{′} {r}^{′}}} \geq {X}_{mr}^{{lm}^{′} {r}^{′}} , ∀ ( mr , {m}^{′} {r}^{′} ) ∈ T , I ∈ {L}^{E} ;$$
$${δ}_{{E}_{mlr}} + {δ}_{{X}_{mr}^{{lm}^{′} {r}^{′}}} \leq 1 , ∀ ( mr , {m}^{′} {r}^{′} ) ∈ T , \\ I ∈ {L}^{E} ; {δ}_{{E}_{mlr}} , {δ}_{{X}_{mr}^{{lm}^{′} {r}^{′}}} ∈ \{ 0 , 1 \} ;$$
$$and , \\ {x}_{m}^{l} , {y}_{m}^{'} , {y}_{ml}^{f} , {z}_{mlr}^{f} , {X}_{mr}^{{lm}^{′} {r}^{′}} \geq 0.$$

10. The method of claim 1, wherein the workforce capacity and capability model is a non-deterministic model.

11. The method of claim 10, wherein the parameters are first parameters, and wherein using the workforce capacity and capability model comprises solving a stochastic programming (SP) problem to maximize the expression, given a plurality of constraints specified by the workforce capacity and capability model, and based on a plurality of second parameters that are random parameters and that are different than the first parameters.

12. The method of claim 11, wherein the workforce capacity and capability model is a two-stage non-deterministic model such that the decision variables comprise one or more first-stage decision variables and one or more second-stage decision variables.

13. The method of claim 12, wherein solving the SP problem comprises:
solving the SP problem at a first stage to generate the values for the first-stage decision variables to provide an estimated solution to the SP problem; and,
solving the SP problem at a second stage later in time than the first stage and for a specific scenario to generate the values for the second-stage decision variables to provide a solution to the SP problem for the specific scenario that is more accurate than the estimated solution to the SP problem.

14. The method of claim 12, wherein C specifies the total entity-owned workforce cost weighted over a plurality of probabilistic scenarios, D specifies the total cross-training cost weighted over the probabilistic scenarios, and E specifies the penalty of the idled regular workforce weighted over the probabilistic scenarios.

15. The method of claim 14, wherein the constraints comprise:
a first constraint to ensure that a total revenue allocated to workforce sources equals a forecasted revenue target in each of a plurality of market offerings;
a second constraint to impose a lower bound on the total revenue as allocated to the workforce sources;
a third constraint to convert revenues in currency amounts into a number of full-time employees (FTEs) needed while considering one or more risk factors, and as associated with a particular probabilistic scenario;
a fourth constraint to enforce a sum of different types of FTE equals a total number of the FTEs needed, as associated with the particular probabilistic scenario;
a fifth constraint to specify FTEs needed per FTE role, as associated with the particular probabilistic scenario;
a sixth constraint to specify a composition of FTE in terms of FTE roles, as associated with the particular probabilistic scenario;
a seventh constraint to balance an initial inventory, a reduced regular FTE used for cross-training, an increased regular FTE trained from other roles, and an idled regular FTE, as associated with the particular probabilistic scenario;
an eighth constraint to ensure that FTEs used for cross-training cannot exceed an available inventory, as associated with the particular probabilistic scenario;
a ninth constraint to ensure that that cross-trained FTEs cannot exceed a final regular FTE number, as associated with the particular probabilistic scenario;
a tenth constraint to forbid cross-training where impermissible, as associated with the particular probabilistic scenario;
one or more eleventh constraints to prevent cross-training idled regular FTEs, as associated with the particular probabilistic scenario; and,
a twelfth constraint to define decision variable domains, as associated with the particular probabilistic scenario.

16. The method of claim 12, wherein M specifies a set of market offerings by the entity, L specifies a set of workforce sources available to the entity, R specifies a set of workforce roles, F specifies a set of full-time employee (FTE) types at the entity, m∈M specifies an index of the market offerings, l∈L specifies an index of the workforce sources, r∈R specifies an index of the workforce roles, f∈F specifies an index of the FTE types, F⊃{reg,ctw} such that reg represents regular FTEs at the entity and ctw represents contingent FTEs at the entity, T⊂(M×R)×(M×R) specifies a set of valid cross-trainings from one pair of a market offering and a role to another pair of a market offering and a role, Ω specifies a set of scenarios, ω∈Ω specifies a scenario representing a realization of the second parameters, and p^{ω} specifying a probability that scenario ω occurs,
wherein the first parameters comprise: Yₘ specifying target revenue by the entity for marking offering m; ρₘ^{l} specifying a cost ratio of revenue generated by a non-entity-owned source
$$I ∈ \frac{L}{{L}^{E}}$$
to the target revenue in market offering m; cₘₗ^{f} specifying cost per FTE of type f per day in marketing offering m from source l; η specifying a number of working days over a planning horizon; μₘᵣ^{lm′r′} specifying a percentage of utilization that is lost due to lead time spent to cross-train an FTE from source l in role r of market offering m to role r′ of market offering m′; θₘ^{l} specifying a lower bound on a percentage of revenue in market offering m allocated to source l; τₘ^{l} specifying an average discounted external rate of an FTE; uₘₗ^{f} specifying a percentage of time of an FTE of type f in market offering m from source l that generates revenue; λₘ^{l} specifying a risk factor for an FTE in marketing offering m from source l; πₘᵣ^{l} specifying a percentage of FTE of role r in market offering m from source l; lₘᵣ^{l} specifying an available inventory of FTE of role r in market offering m from source l; a large positive number M greater than a threshold; and, αₘₗᵣ^{ω} specifying a cost of the idled regular FTE of role r in market offering m from source l in scenario ω,
wherein the second parameters comprise: ũₘₗ^{f} specifying a commitment rate of type f FTE in market offering m from source l; and, \tilde{λ}ₘ^{l} specifying a risk factor of an FTE in market offering m from source l,
wherein the first-stage decision variables comprise: xₘ^{l} specifying revenue allocated to source l in market offering m,
and wherein the second-stage decision variables comprise: yₘ^{lω} specifying FTE for market offering m from source l in scenario ω; yₘₗ^{fω} specifying FTE of type f for market offering m from source l in scenario ω; zₘₗᵣ^{fω} specifying FTE in role r of type f for market offering m from source l in scenario ω; X_{mrω}^{lm′r′} specifying regular FTE from source l in role r of market offering m trained to role r′ of market offering m′ in scenario ω; Eₘₗᵣ^{ω} specifying idled regular FTE of role r in market offering m from source l in scenario ω; δ_{E}_{ₘₗᵣ}^{ω}:=1 specifying whether the idled regular FTE of role r in market offering m from source l can be positive in scenario ω; and,
$${δ}_{{X}_{mr}^{{lm}^{′} {r}^{′}}}^{ω} := 1$$
specifying whether cross-training from source l in role r of market offering m to role r′ of market offering m′ can be positive in scenario ω.

17. The method of claim 16, wherein the expression is
$${\sum }_{m} {\sum }_{l} {x}_{m}^{l} - {\sum }_{m} {\sum }_{I ∈ L / L} E {ρ}_{m}^{l} {x}_{m}^{l} - {\sum }_{ω} {p}^{ω} ( η {\sum }_{m} {\sum }_{I ∈ L} E {\sum }_{f} {c}_{ml}^{f ω} + η {\sum }_{m} {\sum }_{I ∈ L} E {\sum }_{r} {c}_{ml}^{reg} {μ}_{mr ω}^{{ml}^{′} {r}^{′}} {X}_{mr ω}^{{lm}^{′} {r}^{′}} + η {\sum }_{m} {\sum }_{I ∈ L} E {\sum }_{r} {α}_{mlr} {E}_{mlr}^{ω} ) ,$$
and wherein the constraints comprise: Σₗxₘ^{l}=Yₘ,∀m∈M; xₘ^{l}≧θₘ^{l}Yₘ,∀m∈M,l∈L; τₘ^{l}η[Σ_{f}uₘₗ^{fω}yₘₗ^{fω}−λₘ^{lω}yₘ^{lω}]=xₘ^{l}m∀m∈M,l∈L^{E},ω∈Ω; Σ_{f}yₘₗ^{fω}=yₘ^{lω},∀m∈M,l∈L^{E},ω∈Ω; Σᵣzₘₗᵣ^{fω}=yₘₗ^{fω},∀m∈M,l∈L^{E},f∈F,ω∈Ω; Σ_{f}zₘₗᵣ^{fω}=πₘᵣ^{l}yₘ^{lω},∀m∈M,l∈L^{E},r∈R,ω∈Ω; zₘₗᵣ^{reg,ω}=lₘᵣ^{l}−Σ_{m′}Σ_{r′}Xₘᵣ^{lm′r′}+Σ_{m′}Σ_{r′}(1−μ_{m′r′}^{lmr})X_{m′r′ω}^{lmr}−Eₗₘᵣ^{ω}, ∀m∈M,l∈L^{E},r∈R,ω∈Ω; Σ_{m′}Σ_{r′}X_{mrω}^{lm′r′}≦lₘᵣ^{l},∀m∈M,l∈L^{E},r∈R,ω∈Ω; Σ_{m′}Σ_{r′}(1−μ_{m′r′}^{lmr})X_{m′r′ω}^{lmr}≦zₘₗᵣ^{reg,ω},∀m∈M,l∈L^{E},r∈R,ω∈Ω; X_{mrω}^{lm′r′}=0,∀(mr,m′r′)∈T,l∈L^{E},ω∈Ω; M□δ_{E}_{ₘₗᵣ}^{ω}>Eₘₗᵣ,∀,∀m∈M,l∈L^{E},r∈R,ω∈Ω;
$$M {•δ}_{{X}_{mr}^{{lm}^{′} {r}^{′}}}^{ω} \geq {X}_{mr ω}^{{lm}^{′} {r}^{′}} , ∀ ( mr , {m}^{′} {r}^{′} ) ∈ T , I ∈ {L}^{E} , ω ∈ Ω ;$$
$${δ}_{{E}_{{ω}_{mlr}}} + {δ}_{{X}_{mr}^{{lm}^{′} {r}^{′}}}^{ω} \leq 1 , ∀ ( mr , {m}^{′} {r}^{′} ) ∈ T , \\ I ∈ {L}^{E} ω ∈ Ω ; {δ}_{{E}_{mlr}}^{ω} , {δ}_{{X}_{mr}^{{lm}^{′} {r}^{′}}}^{ω} ∈ \{ 0 , 1 \} , ω ∈ Ω ;$$
$${x}_{m}^{l} , {y}_{m}^{l ω} , {y}_{ml}^{f ω} , {z}_{mlr}^{f} , {X}_{mr ω}^{{lm}^{′} {r}^{′}} \geq 0.$$

18. A non-transitory computer-readable data storage medium storing a computer program, execution of the computer program by a processor causing a method to be performed, the method for optimizing a workforce capacity and capability at an entity and comprising:
retrieving values for a plurality of parameters related to the workforce capacity and capability at the entity; and,
employing a workforce capacity and capability model to generate values for a plurality of decision variables related to the workforce capacity and capability at the entity, based on the values for the parameters that have been received, wherein
the workforce capacity and capability model models uncertainty associated with a workforce,
the values for the decision variables assist evaluation of workforce capacity and capability strategic decisions, and
the workforce capacity and capability model maximizes an expression A−B−C−D−E, where A specifies total revenue allocated, B specifies a cost of service delivery from non-entity-owned sources, C specifies a total entity-owned workforce cost, D specifies a total cross-training cost, and E specifies a penalty of idled regular workforce.

19. A system for optimizing a workforce capacity and capability at an entity, comprising:
a processor; and,
a computer-readable data storage medium to store a computer program, and a plurality of parameters related to the workforce capacity and capability at the entity,
wherein the computer program is to apply a workforce capacity and capability model to generate values for a plurality of decision variables related to the workforce capacity and capability at the entity, based on the values for the parameters that have been received, wherein
the workforce capacity and capability model models uncertainty associated with a workforce,
the values for the decision variables assist evaluation of workforce capacity and capability strategic decisions, and
the workforce capacity and capability model maximizes an expression A−B−C−D−E, where A specifies total revenue allocated, B specifies a cost of service delivery from non-entity-owned sources, C specifies a total entity-owned workforce cost, D specifies a total cross-training cost, and E specifies a penalty of idled regular workforce.
